(19) United States
(12) Patent Application Publication
(10) Pub. No.: US 2017/0280934 A1
(43) Pub. Date: Oct. 5, 2017

(54) Rotary Toaster

(71) Applicant: John Okonski, Lakefield (CA)

(72) Inventor: John Okonski, Lakefield (CA)

(21) Appl. No.: 15/085,792

(22) Filed: Mar. 30, 2016

(51) Int. Cl. A47J 37/08

(52) U.S. Cl. CPC A47J 37/0835

(57) ABSTRACT

A toaster is provided with rotary slots propelled by an electric motor. The toaster utilizes infrared waves to heat or bake breads such as bagel, muffins or the like and is provided with a sensor that discontinues infrared heating after the temperature reaches a certain set temperature.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to cooking appliances. More particularly, to a toaster that is capable of completely toasting bread products, such as muffins, bagels and the like.

### 2. Description of Related Art Including Information Disclosed Under 37 CFR 1.97 and 37 CFR 1.98.

Different types of breads such as muffins, bagels and the like are a preferred choice of people who prefer to have small meals all day rather than three large meals. Typically, these breads are cooked using a toaster. In the past a toaster having stationary toasting slots with a timer have been used to bake or toast the different breads. However, it has been observed that using conventional toasters that breads do not get toasted at their edges. Hence, toasters with rotary slots have been introduced to fully bake or toast the breads. There are a number of different types of toaster with rotary slots available in the prior art. For example, WIPO Patent Application No. PCT/EP1996/001711 to Borgward discloses a toaster with at least one toasting chamber for receiving goods to be toasted, in particular slices of toast, has at least one loading opening and at least one discharge opening for loading goods to be toasted and for removing toasted goods, as well as a transport device for toasted goods contained in the toaster. The functional elements of this toaster are surrounded by a wall of a housing, supported on a chassis that contains built-in control and/or display means. The transport device moves one or several pieces of toasted goods in the toasting chamber by means of a spiral guiding system on a spiral transport path from the loading opening to the discharge opening. At the same time, the toasted goods are continuously and substantially uniformly exposed to heat irradiated by at least one spiral heating element. Another prior art is WIPO Pat. Application No. PCT/GB1988/000908 which discloses a rotary toaster having a casing which is insulated from a housing. This housing is basically an oven, which fits closely around a carrier. The carrier is disc-shaped and revolves about a central axis. The speed of rotation is controlled to produce the desired toast. Bread is delivered to the carrier via a chute either manually or automatically from a magazine. Speed of delivery is controlled by the rotation of the carrier via a sprocket, crank and lever arrangement and a slice dispenser. The bread is located on the carrier by short spikes and/or ribs. The degree of browning/color of the toast is measured by a device which influences speed control which in turn dictates the speed of the carrier. Toast is removed from the carrier by the action of a spring loaded lever.

### BRIEF SUMMARY OF THE INVENTION

This invention is directed to a toaster with rotary slots propelled by an electric motor. The toaster utilizes infrared waves to heat or bake breads such as bagel, muffins or the like and is provided with a sensor that discontinues infrared heating after the temperature reaches a certain set temperature.

It is an object of the present invention is to provide a toaster with rotary slots instead of stationary slots.

It is another object of the present invention to provide a toaster that utilizes infrared waves to heat or bake breads such as bagel, muffins or the like.

It is yet another object of the present invention to provide a toaster for toasting a bagel or bread that is toasted or baked evenly including edges.

It is another object of the present invention to provide a toaster, which in the stationary stage will accommodate any type of bread that is too large or has a very odd shape.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 depicts a top view of the toaster with rotary slots.

FIG. 2 depicts a side view of the toaster with rotary slots.

### DETAILED DESCRIPTION OF THE INVENTION

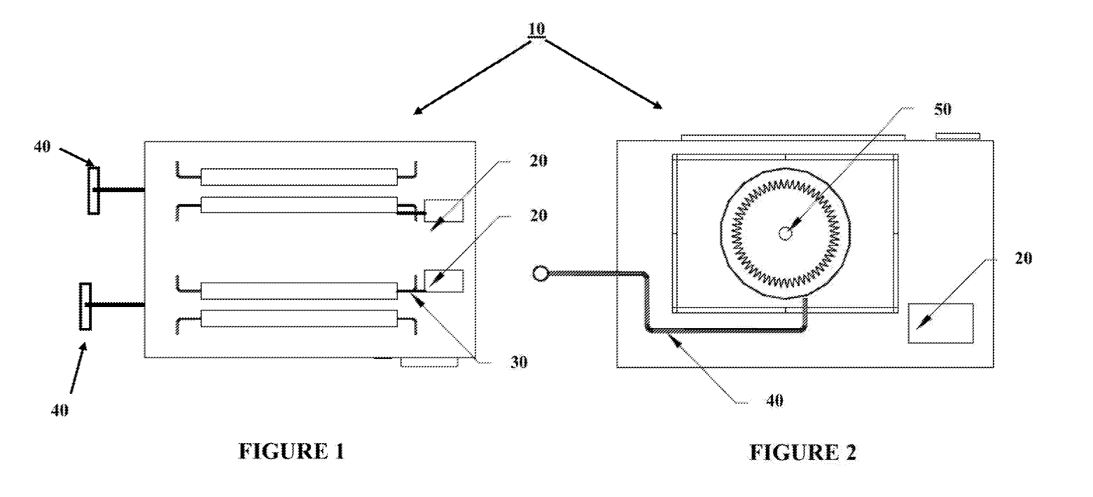

Referring now to FIG. 1, there is shown and illustrated a top view of one preferred embodiment of a toaster of the present invention. The toaster 10 of the present invention has two equal sections. Each section or unit comprises an electric motor 20, a spiral drive 30 and a mechanism 40 to lower the bread or bagel into the toaster. Referring now to FIG. 2, there is shown and illustrated a side view of the toaster 10 that houses an electric motor 20 on one side, a spiral drive 30, a mechanism 40 to lower the bread, bagel or like into the toaster and a rotating slot 50 rotating at a certain speed and completing a full circle. The rotating slot 50 is configured with the spiral drive 30 to heat the bread or bagel completely and evenly.

In a preferred embodiment of the invention the bread to be baked or toasted is placed inside and lowered manually into position using the lowering mechanism 40. The lowered bread is surrounded on both the sides by the rotating slots 50 configured with the spiral drive 30. Once the toaster 10 is plugged into a power source, the electric motor 20 installed in each half of the toaster 10 powers the slots 50 to rotate. The slots 50 due to their rotating movement and infrared waves radiated by spiral drive 30 provide even heating to whole bread including the edges. A temperature sensing sensor (not shown) is housed inside the toaster 10 and discontinues heating the bread when the temperature reaches a specific temperature that is equal to a temperature limit already set by the user. Once the infrared heating is stopped the toasts in both halves pop out automatically. It may be noted that the space or cavity between the two adjacent rotary slots 50 is enough to accommodate any type of bread or bagel that is too large or having very odd shape.

While the present invention has been described with reference to particular embodiments, it should be understood that the embodiments are illustrative and that the scope of the invention is not limited to these embodiments. It is contemplated that variations, modifications, additions and improvements fall within the scope of the invention.

I claim:

1. An electrical appliance for complete heating of a bread, comprising:
at least one heating unit having at least one heating unit; at least one electric motor; at least one rotary slot; and, at least one spiral drive.
a temperature sensor housed in said heating unit wherein said temperature sensor is set by a user to a specific temperature limit.; and,
a mechanism to lower the bread into a cavity wherein said at least one heating unit facilitates heating the bread using infrared waves.

2. The electrical appliance for complete heating of a bread according to claim 1, wherein the electrical appliance is a toaster.

3. The electrical appliance for complete heating of a bread according to claim 2, wherein at least one said electric motor facilitates rotational movement of at least one said rotary slot.

4. The electrical appliance for complete heating of a bread according to claim 3, wherein the at least one said spiral drive is configured to at least one said rotary slot.

5. The electrical appliance for complete heating of a bread according to claim 4, wherein the bread is evenly heated using at least one said spiral drive.

6. The electrical appliance for complete heating of a bread according to claim 1, wherein said sensor discontinues heating the bread when the temperature inside the toaster reaches said set specific temperature limit.

7. The electrical appliance for complete heating of a bread according to claim 6, wherein heated bread pops out of a said rotary slot upon discontinuation of heating.
